(19) United States
(12) Patent Application Publication
(10) Pub. No.: US 2016/0220066 A1
(43) Pub. Date: Aug. 4, 2016

(54) ACCESSORIES FOR BARBEQUE GRILL

(71) Applicant: Charles Lawrence Roberts, Charlotte, NC (US)

(72) Inventor: Charles Lawrence Roberts, Charlotte, NC (US)

(21) Appl. No.: 15/098,729

(22) Filed: Apr. 14, 2016

Related U.S. Application Data
(63) Continuation-in-part of application No. 14/082,465, filed on Nov. 18, 2013.
(60) Provisional application No. 62/147,828, filed on Apr. 15, 2015.
(60) Provisional application No. 61/727,857, filed on Nov. 19, 2012.

(51) Int. Cl. A47J 37/07

(52) U.S. Cl. CPC A47J 37/0786

(57) ABSTRACT

A barbeque accessory assembly for use with a barbeque grill having an enclosure within which is contained a fire ring positioned over a fire box, and a grill grate positioned in vertically spaced relation above the fire ring. A deflector plate is adapted for being positioned in the enclosure between the grill grate and the fire box, and a plurality of openings extend around the periphery of the deflector plate for permitting heat and smoke to rise along the sides of the grill above the level of the deflector plate 190 into an area of the grille grate where the food is being cooked or smoked.

### CROSS-REFERENCE TO RELATED APPLICATIONS

This application claims priority to U.S. Provisional Application No. 61/727,857 filed Nov. 19, 2012, the contents of which are incorporated by reference herein; U.S. Utility application Ser. No. 14/082,465, filed Nov. 18, 2013; the contents of which are incorporated by reference herein; and U.S. Provisional Application No. 62/147,828, filed Apr. 15, 2015, the contents of which are incorporated by reference herein.

### TECHNICAL FIELD AND BACKGROUND OF THE INVENTION

This application relates to accessories for use with barbeque grills. In particular, the disclosure of this application relates specifically to accessories designed for use with a kamado-type grill product. The most well-known and popular such grill is marketed under the trademark Big Green Egg. Such grills include a generally egg-shaped outer shell within which are contained various components intended to permit various types of food to be cooked in various ways. This invention provides several interior components that are designed to provide maximum utility of the grill for differing cooking methods while maintaining and maximizing the interior capacity of the grill in a manner not presently available.

### SUMMARY OF THE INVENTION

It is therefore an object of the present invention to provide a grill insert according to several alternatives that permits the level of the charcoal-created fire to be raised to a height closer to the grille grate on which the food is being cooked.

According to one preferred embodiment of the invention, a barbeque accessory assembly for use with a barbeque grill is provided. The barbeque grill is of the type having an enclosure within which is contained a fire ring positioned over a fire box, and a grill grate positioned in vertically spaced relation above the fire ring. The accessory assembly includes a deflector plate adapted for being positioned in the enclosure between the grill grate and the fire box, and a plurality of openings extending around the periphery of the deflector plate for permitting heat and smoke to rise along the sides of the grill above the level of the deflector plate into an area of the grille grate where the food is being cooked or smoked.

According to another embodiment of the invention, the openings in the deflector plate communicate with an outer peripheral edge of the deflector plate.

According to another embodiment of the invention, the openings in the deflector plate communicate with an outer peripheral edge of the deflector plate, and comprise crenellations formed by bending segments of the edge of the deflector plate out of a plane defined by a major surface of the deflector plate.

According to another embodiment of the invention, the deflector plate comprises first and second semicircular plate segments.

According to another embodiment of the invention, the accessory assembly includes a component base for being positioned in the enclosure above the fire box and below the grille grate, and adapted for receiving and supporting the deflector plate.

According to another embodiment of the invention, a component bar is provided for extending across the component base from a first side to a second side. The component bar includes a slot for receiving a mating tab formed on a bottom surface of the deflector plate for being inserted in the slot.

According to another embodiment of the invention, the enclosure and the grille grate are circular in horizontal cross-section.

According to another embodiment of the invention, the openings in the deflector plate extend in an equally-spaced configuration around the periphery of the deflector plate.

According to another embodiment of the invention, the deflector plate is circular and sized to fit into the grille enclosure in a closely-fitting position above the fire box and below the grille grate.

According to another embodiment of the invention, a barbeque accessory assembly for use with a barbeque grill is provided, the barbeque grill being of the type having an enclosure within which is contained a fire ring positioned over a fire box, and a grill grate positioned in vertically spaced relation above the fire ring, and comprising a basket adapted for being positioned and supported in the enclosure above the firebox and below the grille grate.

According to another embodiment of the invention, the basket is sized to be supported on a top surface of the fire box.

According to another embodiment of the invention, the basket includes vertically extending sidewalls adapted to extend upwardly away from the fire box and towards the grill grate.

According to another embodiment of the invention, the basket includes vertically extending sidewalls adapted to extend upwardly away from the fire box and towards the grill grate, and a flange positioned on the basket above the sidewalls and adapted to rest on an upper peripheral surface of the fire ring above the fire box and below the grill grate, with a bottom of the basket extending below the upper peripheral surface of the fire ring.

According to another embodiment of the invention, the enclosure and the grille grate are circular in horizontal cross-section and wherein the shape of the basket is selected from the shapes consisting of semicircular in horizontal cross-section and circular in cross-section.

According to another embodiment of the invention, the accessory assembly includes a support ring adapted for being positioned on an annular top surface of the fire ring and on which the basket is adapted to rest during use.

According to another embodiment of the invention, the support ring is formed of two semicircular ring segments.

According to another embodiment of the invention, a basket is provided, and is adapted for being placed in a barbeque grill of the type comprising an enclosure within which is contained a fire ring positioned over a fire box, and a grill grate positioned in vertically spaced relation above the fire ring, the basket further adapted for being positioned and supported in the enclosure above the firebox and below the grille grate.

According to another embodiment of the invention, the basket is sized to be supported on a top surface of the fire box.

According to another embodiment of the invention, the basket includes vertically extending sidewalls adapted to extend upwardly away from the fire box and towards the grill grate.

According to another embodiment of the invention, the basket includes vertically extending sidewalls adapted to extend upwardly away from the fire box and towards the grill grate, and a flange positioned on the basket above the sidewalls and adapted to rest on an upper peripheral surface of the fire ring above the fire box and below the grill grate, with a bottom of the basket extending below the upper peripheral surface of the fire ring.

### BRIEF DESCRIPTION OF THE DRAWINGS

The invention will be more fully understood when taken in connection with the following drawings:

FIG. 1 is an exploded view of one embodiment of a grill with which the invention is used;

FIG. 2 is an exploded view of the component bar and component bar receiving bracket according to one embodiment of the invention;

FIG. 3 shows two views of the placement of the component bar receiving bracket between the fire ring and the firebox;

FIG. 4 is a top view of the firewall deflector plate according to one embodiment of the invention;

FIG. 5 is a side view of the firewall deflector plate according to one embodiment of the invention;

FIG. 6 is a top view of a deflector plate according to one embodiment of the invention;

FIG. 7 is a side view of the deflector plate shown in FIG. 6 according to one embodiment of the invention;

FIG. 8 is a top view of a drip pan rack according to one embodiment of the invention;

FIGS. 9 and 10 are perspective views of the firewall deflector plate and component bar in a drip pan rack configuration;

FIG. 11 is a perspective view showing the firewall deflector plate and component bar in a full deflection configuration;

FIG. 12 is a side elevation showing placement of the deflector plates in the component bar in the full deflection configuration;

FIG. 13 is a perspective view of a roasting tower attachment for cooking food items;

FIG. 14 is a perspective view of a rib tower arrangement for ribs in a vertical orientation.

FIG. 15 is a composite view of an assembly base, deflector plate and component bars according to an embodiment of the invention;

FIG. 16 is a perspective view of a divider plate that fits into the component bar and sits on the assembly base, shown in a fragmentary view;

FIG. 17 is an exploded, fragmentary view of a basket support bracket assembly that fits onto the assembly base, shown in a fragmentary view;

FIG. 18 is an exploded view, with parts broken away and certain components separately illustrated for clarity, of an alternative embodiment of a grill including accessories according to a preferred embodiment of the invention;

FIG. 19 is a top plan view of the interior of the grill shown in FIG. 18;

FIG. 20 is a top plan view according to FIG. 19 with a basket in place on one side of the grill;

FIG. 21 is a top plan view according to FIG. 20 with a grill grate positioned over the basket; and

FIG. 22 is view looking into the fire box, showing the support rings in position on the top rim of the fire box, the charcoal basket in position on the support rings and the grille grate on which the food is placed positioned on the fire ring.

### DETAILED DESCRIPTION OF THE PREFERRED EMBODIMENT

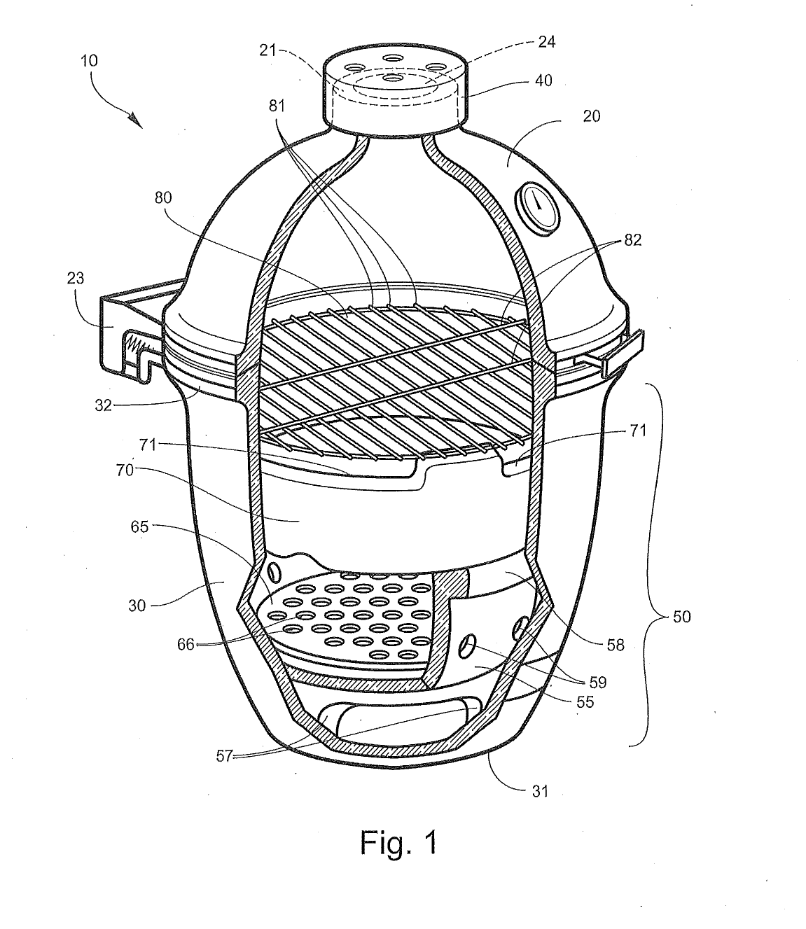

Referring now to FIG. 1, a kamado-type barbeque grill 10 of one type with which the accessories according to the invention can be used is described. Grill 10 includes a lid 20, a base 30, a damper top 40, and a fuel assembly 50.

Lid 20 includes a chimney 21, a bottom edge 22, and a handle 23. Lid 20 is substantially dome shaped. Chimney 21 protrudes outwardly from the top of lid 20 and defines a cylindrical opening 24. Opening 24 communicates with the interior of lid 20.

Base 30 is an inverted dome-shaped structure including a flat bottom 31 and an annular upper edge 32.

Damper top 40 is releasably connectable with chimney 21 and aligns with opening 24. When connected to chimney 21, damper top 40 is used to regulate the upward flow of heated air, and/or smoke through opening 24 of chimney 21. In a closed position, damper top 40 can completely or substantially prevent the flow of heated air, and/or smoke outwardly from the interior of lid 20.

Fuel assembly 50 includes a fire box 55; a fire grate 65, a fire ring 70, and a grill grate 80. When assembled, the fuel assembly 50 fits inside the base 30 and is covered by lid 20. Fire box 55 includes a bowl 56, supports 57, and a flange 58. Bowl 56 has several openings 59 in its side walls to allow for the flow of air into and out of fire box 55.

Fire grate 65 is substantially disc-shaped and has a plurality of perforations 66. Fire grate 65 provides a durable surface for igniting and burning heating fuel such as, for example, charcoal and wood. Perforations 66 allow air to flow through grate 65 in order to support combustion of the fuel.

Fire ring 70 sits on top of the flange 58 of the fire box 55 and provides the proper amount of spacing between the fuel and the food being cooked. The upper edge of fire ring 70 may include several recesses 71.

The grill grate 80 is a substantially circular structure formed of parallel bars 81 held in position by perpendicular cross bars 82, with an outer diameter that permits it to rest on the top edge of fire ring 70.

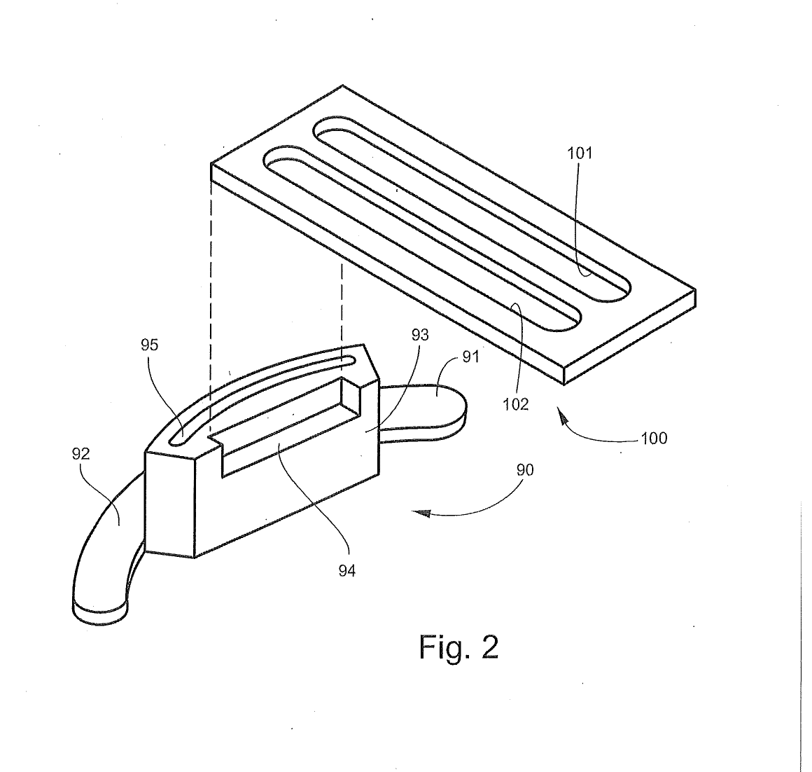

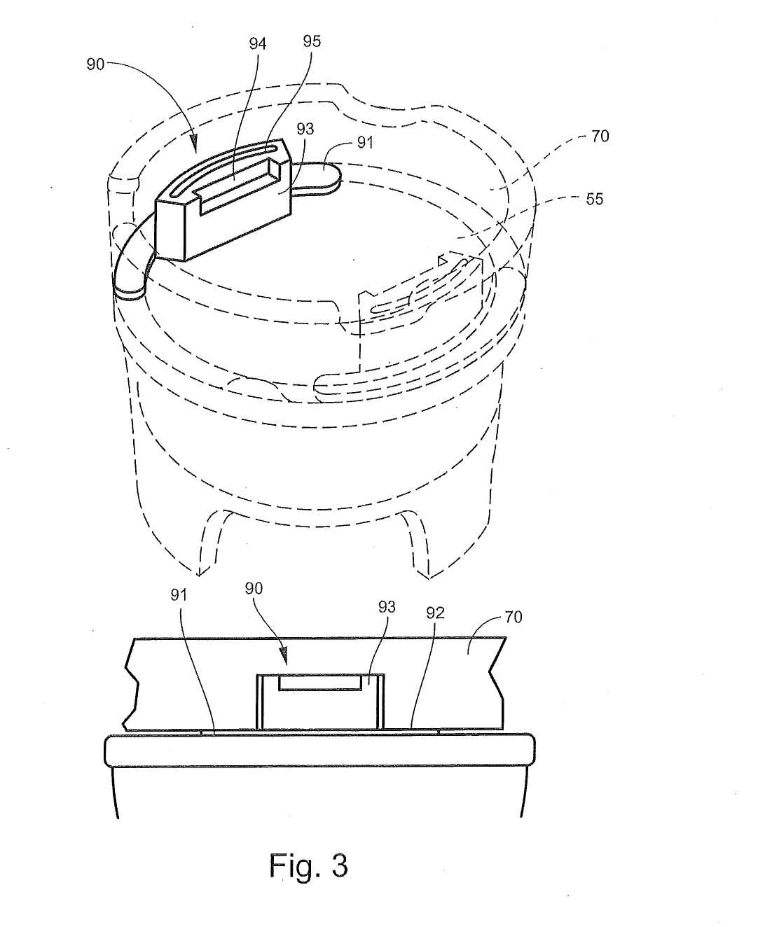

Referring now to FIGS. 2 and 3, principal components of the novel interior assembly include a component bar receiving bracket 90, of which two are required, and a component bar 100, each fabricated from suitable steel or iron material. Each bracket 90 includes a pair of outwardly-extending curved arms 91, 92 attached to a curved central body 93 in which is formed a transversely-extending notch 94 and a curved slot 95.

The component bar 100 is elongate and includes two parallel slots 101 and 102. As shown in FIG. 2, one end of the component bar 100 is shaped and sized to fit into the notch 94 of the bracket 90.

Two brackets 90 are positioned with their respective arms 91, 92 resting on the top edge of the fire box 55 and held in position by the weight of the fire ring 70 which sits on top of the arms 91, 92. The two brackets 90 are positioned opposite each other on the fire box 55 in the manner described immediately above. The component bar 100 is positioned with opposite end edges fitted into the notches 94 and therefore bisects the interior annular space of the base 30. Note also in FIG. 3 that the body 93 of the bracket 90 extends radially-inwardly into the volume of the base 30. The component bar 100 is thus used to support various attachments that are provided with flanges that fit into the slots 101, 102, as described below.

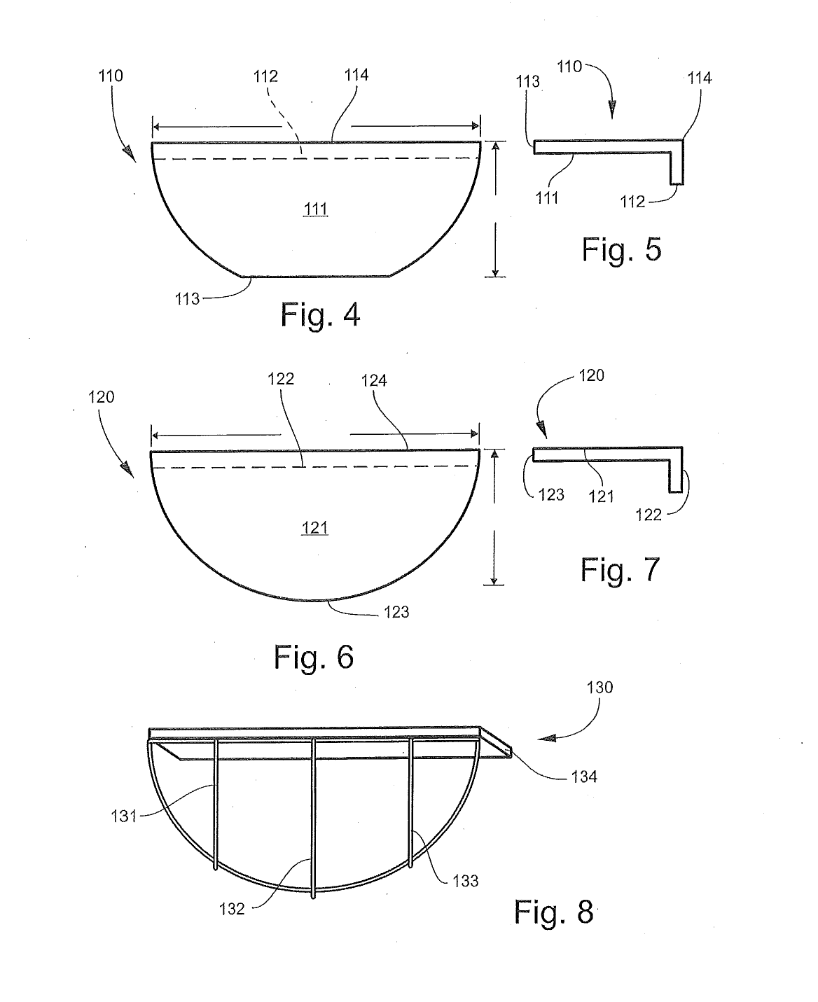

FIG. 4 illustrates a firewall deflector plate 110 that includes a solid steel or iron heat deflector 111 and a support flange 112 that, in one configuration, is inserted into one of the slots 101 or 102 in the component bar 100. Note that the firewall deflector plate 110 has a bottom edge 113 and a top edge 114 that are parallel to each other.

FIG. 5 is a side view of the firewall deflector plate 110 showing deflector 111 and the support flange 112.

FIG. 6 illustrates a deflector plate 120 that includes a solid steel or iron heat deflector 121 and a support flange 122 that, in one configuration, is inserted into one of the slots 101 or 102 in the component bar 100. Note that the deflector plate 120 has a bottom edge 113 that is arcuate, whereas the top edge 114 is straight.

FIG. 7 is a side view of the deflector plate 120 showing deflector 121 and the support flange 122.

FIG. 8 shows a drip pan rack 130 formed of iron or steel bars 131-133 varied in length and captured between a support flange 134 and an arcuate bar 135.

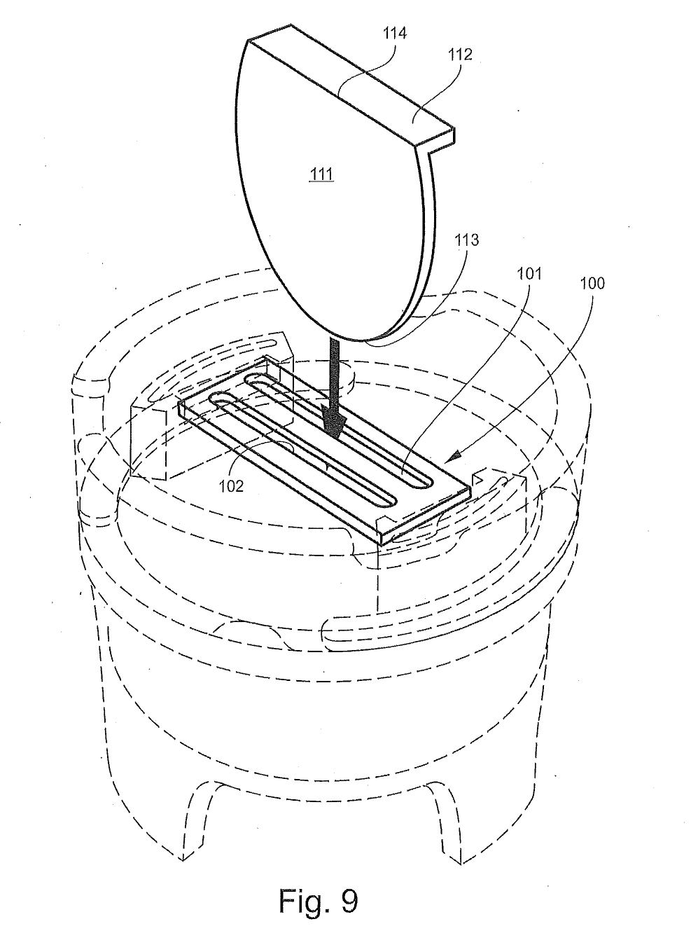

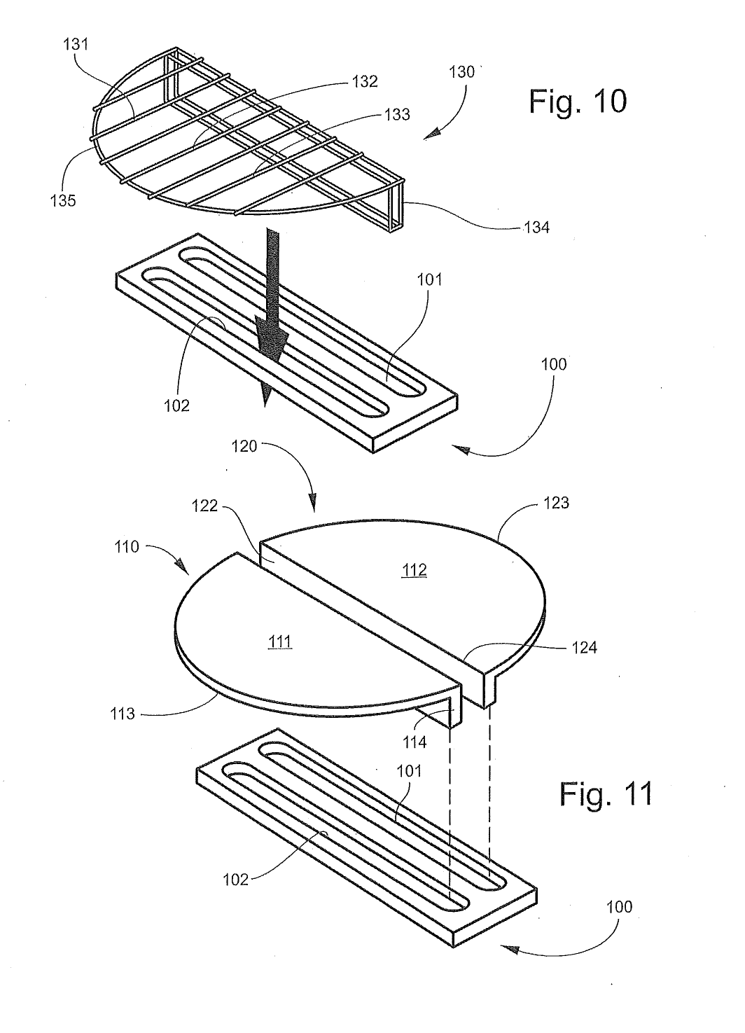

Use of the structures shown in FIGS. 2-8 is illustrated in FIGS. 9-12. In FIG. 9, the firewall deflector plate 110 is shown, with the deflector 111 inserted into slot 101 of the component bar 100 and supported in a vertical, depending position by the support flange 112. The deflector 111 has the effect of dividing the fire box 55 in half. If indirect cooking is desired, the fuel can be placed on one side of the deflector 111 and the food placed on the half of the grill grate 80 positioned over the other side of the deflector 111. As shown in FIG. 10, if use of a drip pan is desired, the support flange 134 of the drip pan rack 130 can be placed in the slot 102 of the component bar 100 so that the support bars 131-133 extend horizontally outwardly. A drip pan can be placed on the drip pan rack 130 to collect drippings from the food being cooked above on the grill grate 80.

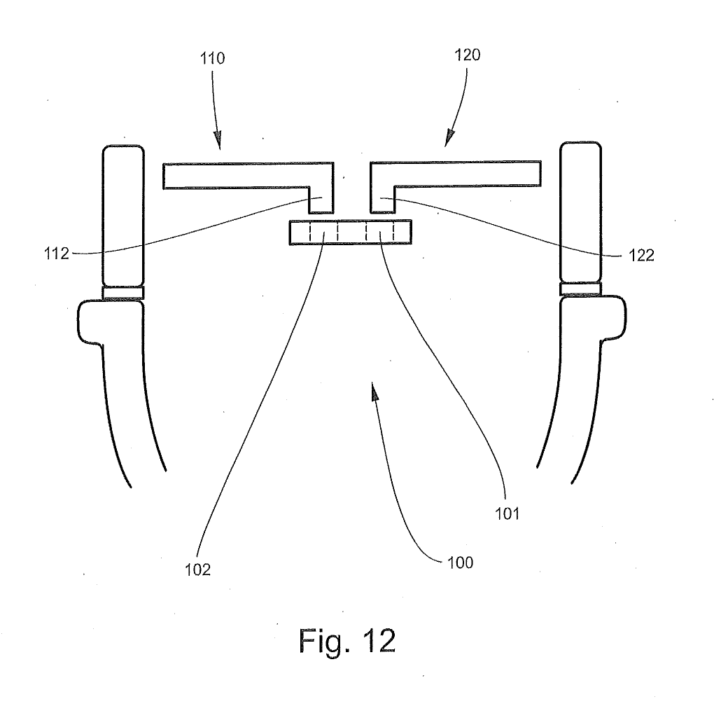

Referring now to FIGS. 11 and 12, if full indirect cooking is desired, the two deflector plates 110 and 120 are positioned with the respective support flanges 114 and 124 in the slots 102 and 101 of the component bar 100. Both deflector plates 110, 120 extend horizontally outward and cover the fire box 55, allowing heat from the fire box 55 to flow upwardly only through a gap around the edge of the base 30 formed by the peripheral edges of the deflector plates 110, 120 and the inner surface of the base 30.

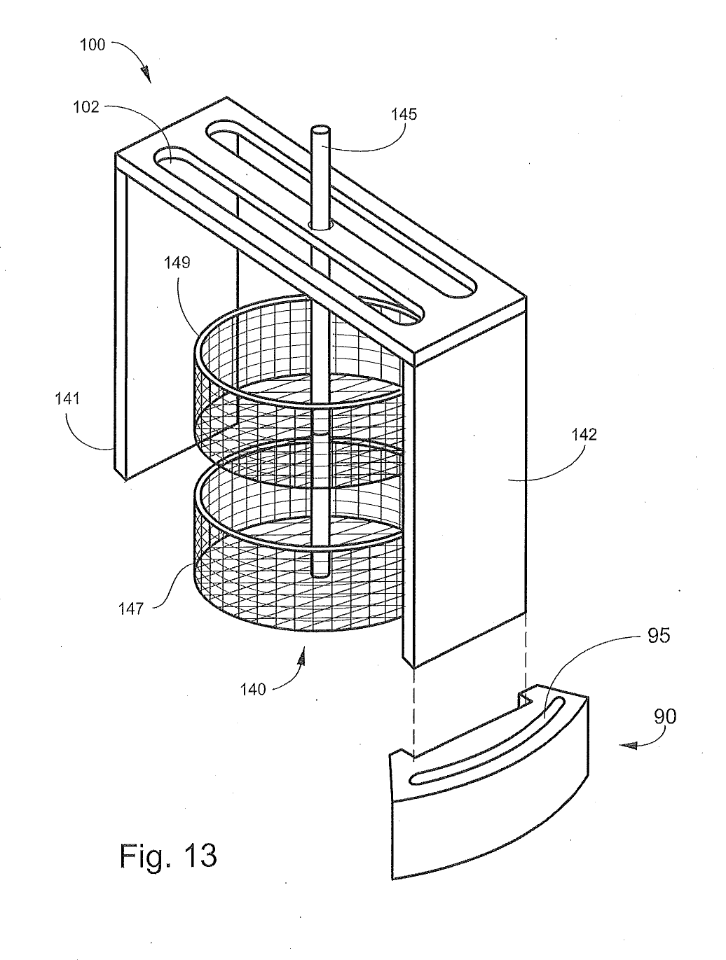

Referring now to FIG. 13, a roasting tower assembly 140 is illustrated, and includes a pair of tower panels 141, 142 that are mounted to the component bar 100 and fit into the respective notches 94 in the two component bars receiving brackets 90. A support rod 145 is suspended through one of the slots 101, 102 in the component bar. A nut or other enlargement on the support rod 145 maintains the support rod 145 at the desired vertical position. As shown, two roasting baskets 147, 149 are mounted on the support rod 145 within the area formed by the height of the tower panels 141, 142. Any suitable number of baskets may be used, and if two or more are used, may be stacked on each other or vertically spaced-apart for better air flow. Also, a hole or enlargement of either or both slots 101, 102 may be formed in the component bar 100 to receive the support rod 145, and the tower panels 141, 142 may be formed with a curved profile permitting them to be placed in the slots 95 of the component bar receiving brackets 90.

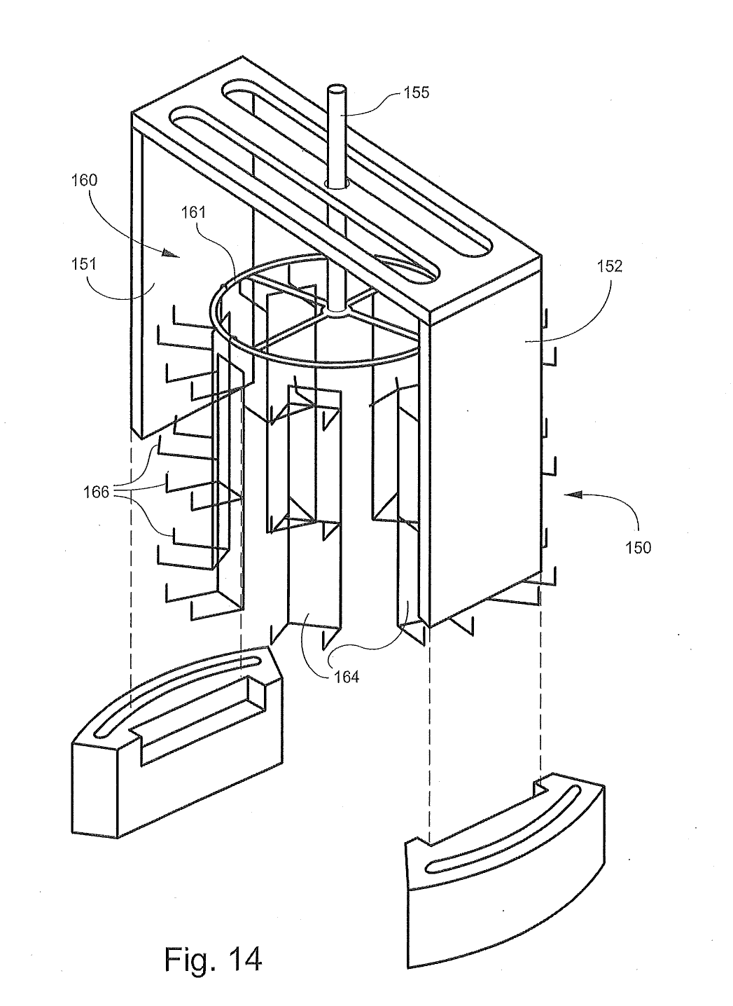

Referring now to FIG. 14, a rib tower assembly 150 is illustrated, and includes a pair of curved tower panels 151, 152 the bottom ends of which are mounted to the component bar 100 and fit into the respective slots 95 in the two component bars receiving brackets 90. The top ends of the tower panels 151, 152 support the component bar 100. A support rod 155 is suspended through one of the slots 101, 102 in the component bar 100. A nut or other enlargement on the support rod 155 maintains the support rod 155 at the desired vertical position. Also, a hole or enlargement of either or both slots 101, 102 may be formed in the component bar 100 to receive the support rod 155.

The support rod 155 supports a rib rack carousel 160 constructed of suitable iron or steel bar stock and formed as a circle with a peripheral rim 161 on which may be suspended one or more rib racks 164. Each rib rack 164 includes hooks 166 on which may be fastened food items such as rib sections for cooking. Suspending the ribs vertically enhances cooking time and flavor by permitting the ribs to be basted during cooking as juices drain down the sides of the ribs.

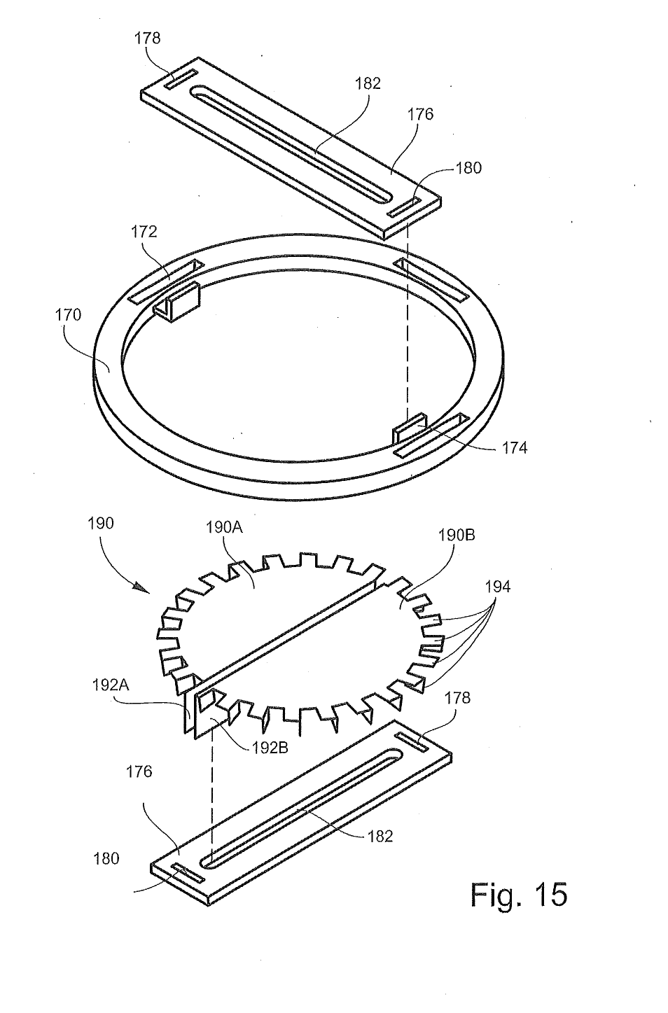

Referring now to FIGS. 15-17, further accessories for use with the grill are shown.

An assembly base 170 is provided for fitting on and being supported by the flange 58. See FIG. 1. The assembly base 170 includes a pair of upwardly extending tabs 172, 174 adapted to receive and support a component bar 176 that includes a pair of mating slots 178, 180 for receiving the tabs 172, 174. The component bar 176 also includes an elongate slot 182 extending down its length that can be used to support any desired attachment.

For example, a deflector plate 190 may be inserted into the slot 182. The deflector plate 190 includes two deflector segments 190A, 190B that include downwardly-extending flanges 192A, 192B that extend into the slot 192. The deflector plate 190 also includes a series of crenellations 194 that permit heat and smoke to rise indirectly and along the sides of the grill above the level of the deflector plate 190 into the area where the food is being cooked or smoked.

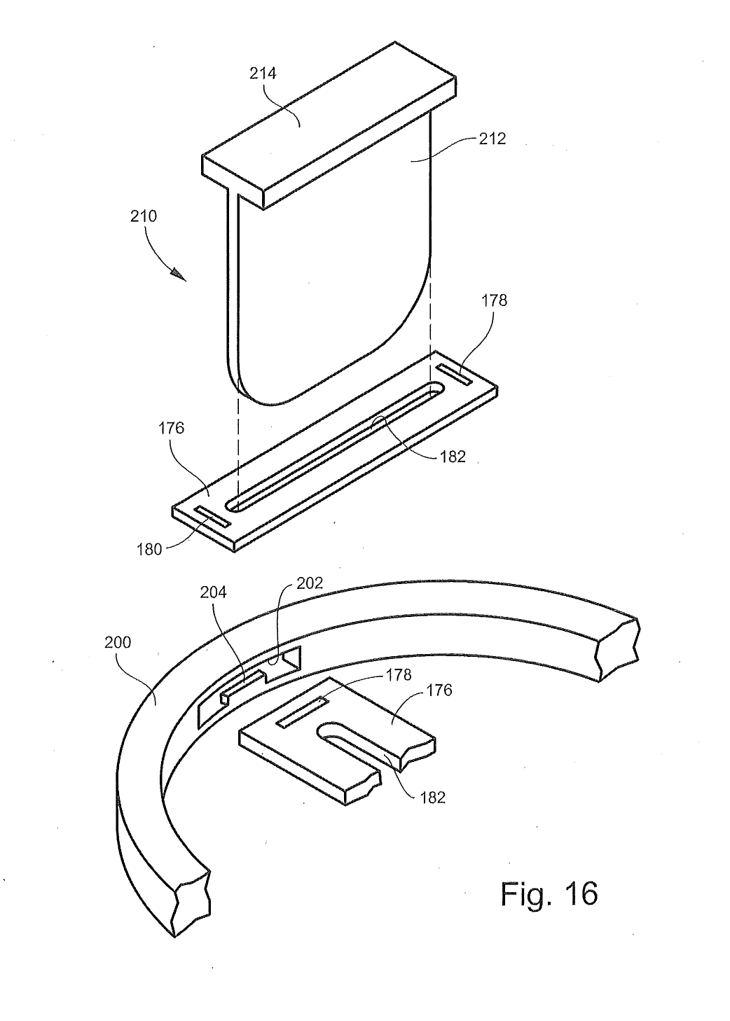

FIG. 16 illustrates a further embodiment of the invention. An assembly base 200, shown fragmentarily, includes an interior slot 202 that supports the component bar 176. The slot178 fits into the slot 202 of the assembly base 200 and is retained by the upwardly-extending tab 204 in the slot 202. The other side of the assembly base 200 mirrors the slot 202 and supports the other end of the component bar 176. As also shown in FIG. 16, the component bar 176 can be used to support a divider plate 210 that includes a divider portion 212 that separates the area of the grill 10 below the component bar 200 into two zones. One zone may contain either no combustible material, or the two zones may contain differing amounts of combustible material in order to permit different amounts of heat to rise upwardly in different areas of the grill 10. The divider portion is supported by a support 214 that rests on the top surface of the component bar 176.

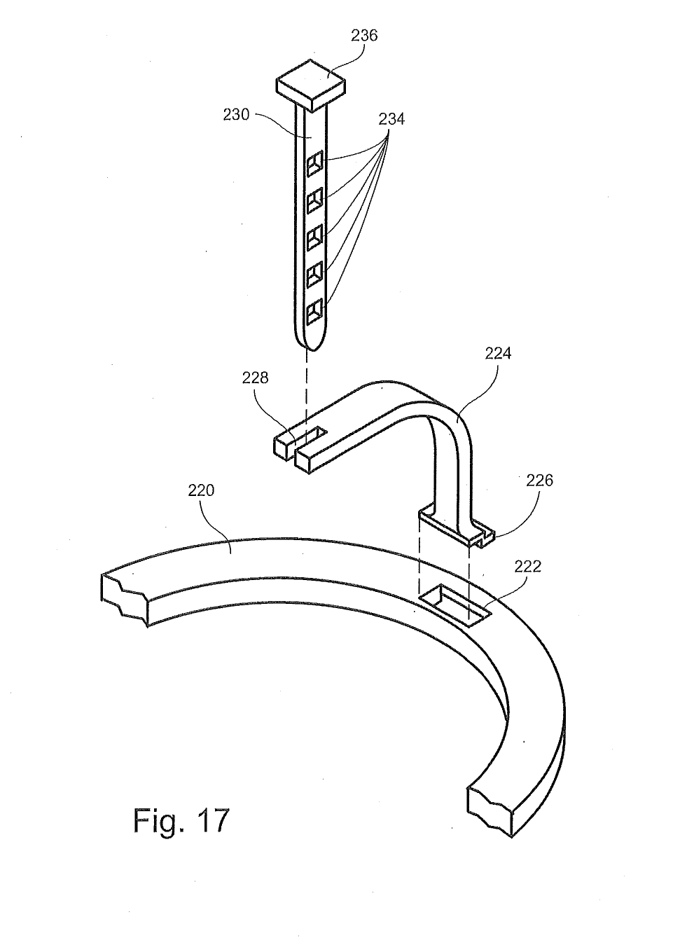

As shown in FIG. 17, an assembly base 220 with a slot 222 in its upper side is provided for supporting a bracket 224 that includes a tab 226 that fits into the slot 222. The bracket 224 has a curve that extends radially-inwardly into the central area of the grill 10, and includes a notch 228 in its end that supports a vertically-extending post 230. The post 230 has a series of openings 234 vertically-spaced along its length from which accessories may be suspended. The post is supported in the notch 228 by an enlarged head 236. The other side of the assembly base 220 mirrors the slot 222 and supports the other end of the component bar 176.

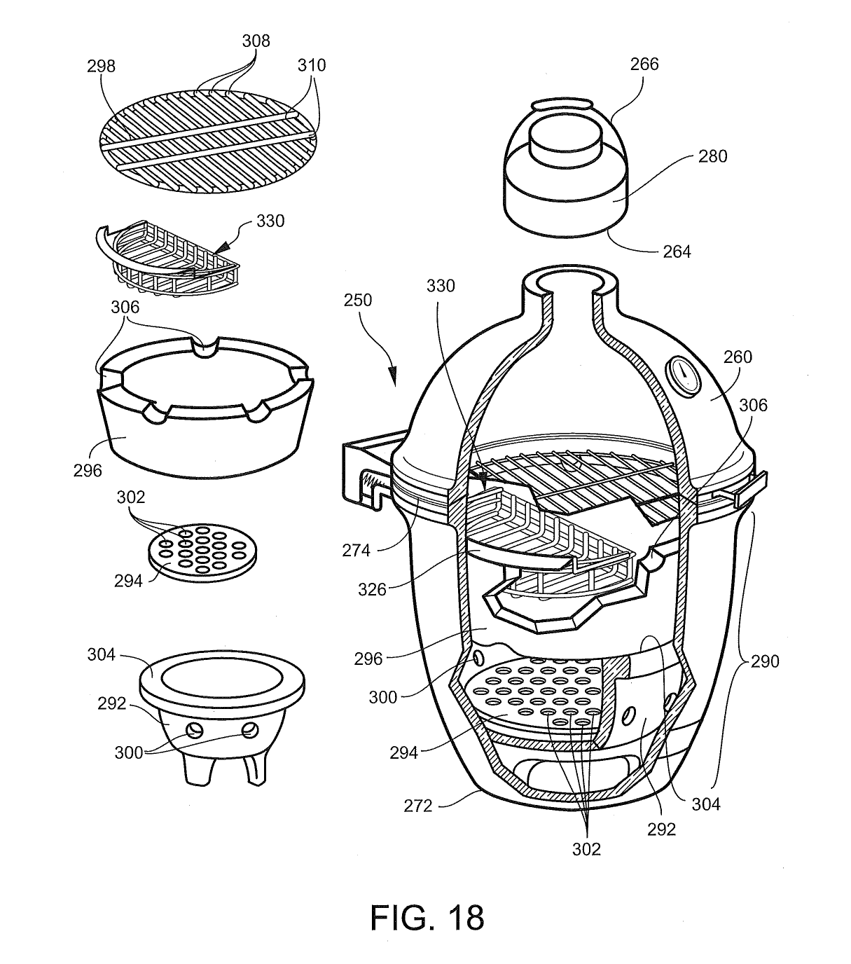

Referring now to FIG. 18, Referring now to FIG. 1, a kamado-type barbeque grill 250 of one type with which the accessories according to the invention can be used is described. Grill 250 includes a lid 260, a base 270, a damper top 280, and a fuel assembly 290.

Lid 260 includes a chimney 262, a bottom edge 264, and a handle 266. Lid 260 is substantially dome shaped.

Base 270 is an inverted dome-shaped structure including a flat bottom 272 and an annular upper edge 274.

Damper top 280 is releasably connectable with chimney 262. When connected to chimney 262, damper top 280 is used to regulate the upward flow of heated air, and/or smoke through the chimney 262. In a closed position, damper top 280 can completely or substantially prevent the flow of heated air, and/or smoke outwardly from the interior of lid 260.

Fuel assembly 290 includes a fire box 292; a fire grate 294, a fire ring 296, and a grill grate 298. When assembled, the fuel assembly 290 fits inside the base 270 and is covered by lid 280. Fire box 292 has several openings 300 in its side walls to allow for the flow of air into and out of fire box 292.

Fire grate 294 is substantially disc-shaped and has a plurality of perforations 302. Fire grate 294 provides a durable surface for igniting and burning heating fuel such as, for example, charcoal and wood. Perforations 302 allow air to flow through fire grate 294 in order to support combustion of the fuel.

Fire ring 296 sits on top of a flange 304 of the fire box 292 and provides the proper amount of spacing between the fuel and the food being cooked. The upper edge of fire ring 296 may include several recesses 306.

The grill grate 298 is a substantially circular structure formed of parallel bars 308 held in position by perpendicular cross bars 310, with an outer diameter that permits it to rest on the top edge of fire ring 296.

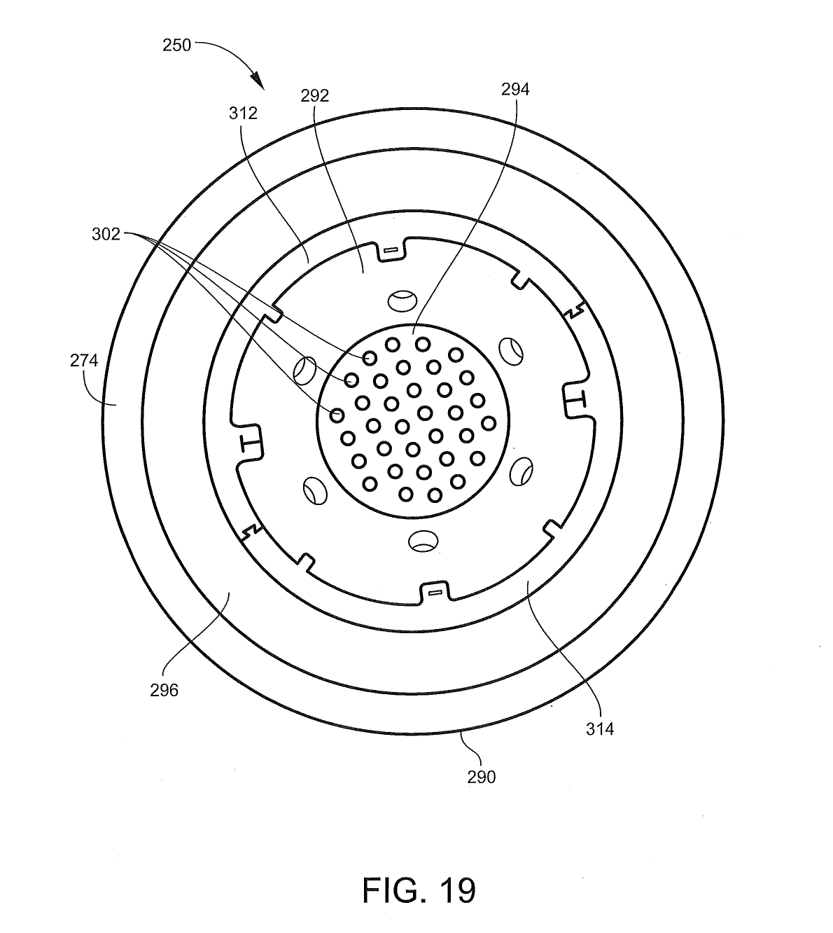

As shown in FIG. 19, first and second support rings 312, 314 are sized and shaped in an arcuate configuration to fit on the upper lip of the fire box 292, as shown.

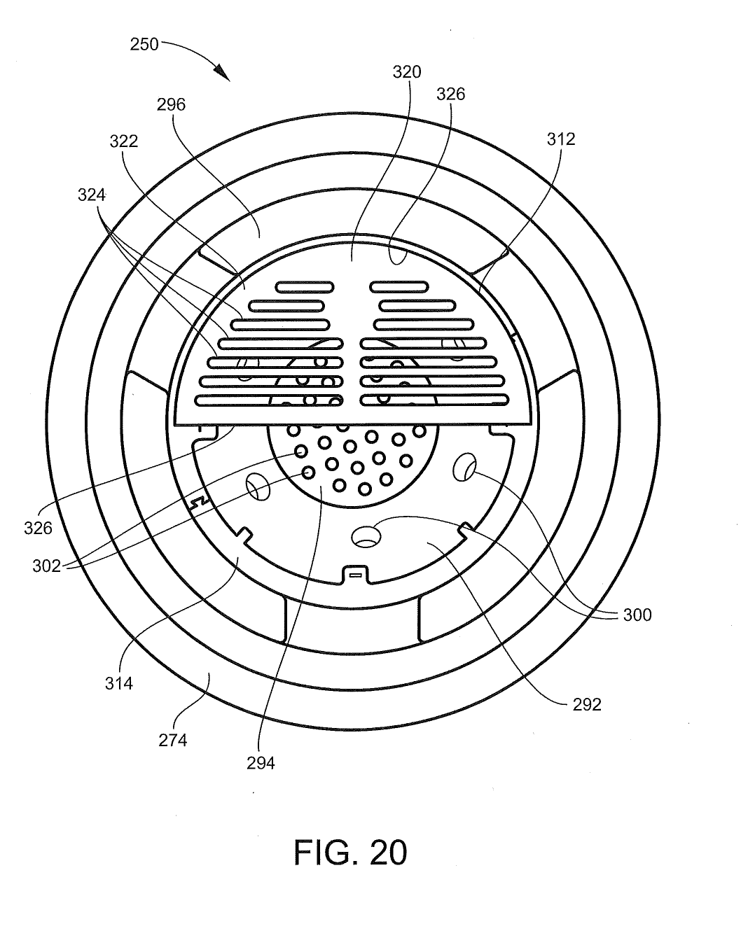

As shown in FIG. 20, a charcoal basket 320 is positioned into the fire box 292 and is supported on the support rings 312, 314. The basket 320 has a semicircular bottom 322 with slots 324 to allow air flow through the bottom 322. The basket 320 also has slotted sidewalls 326 that extend upwardly from the bottom 322, and which conform generally in shape to the shape of the semicircular bottom 322.

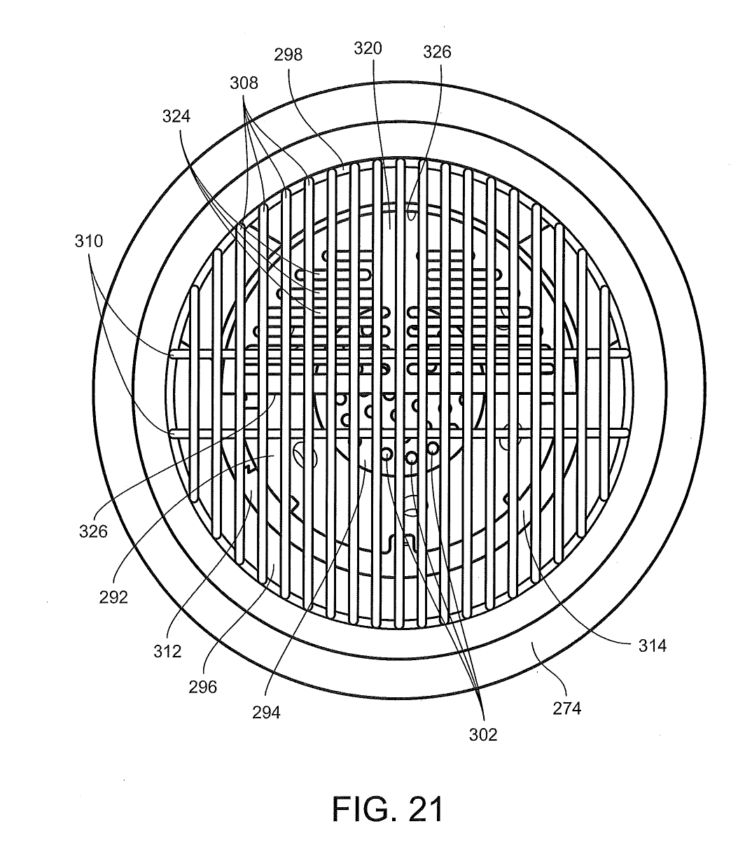

Charcoal is placed in the basket 320 and is lit to create a fire much closer to the food-supporting grill grate 298 than is typical, therefore allowing quicker cooking and/or searing of the food, when desired, and with less charcoal usage. In the configuration shown in FIG. 21, the grill grate 298 is placed on top of the fire ring 296, so that half of the grill grate 298 is exposed to heat from the charcoal, if any, in the bottom of the base 270 and half is exposed to heat from the closer fire in the basket 320. Alternatively, no charcoal need be lit in the bottom of the base 292.

A further alternative is to place two baskets 320 on the support rings 312, 314 so that the entire grill is used with a fire that is closer to the food on the grill grate 298, allowing quicker cooking, and/or searing of the food.

Alternatively, a pan can be placed in the basket 320 with water when cooking indirectly.

Alternatively, two baskets 320 can be placed on the support rings 312, 314 so that pans with water can be placed in both pans for indirect cooking.

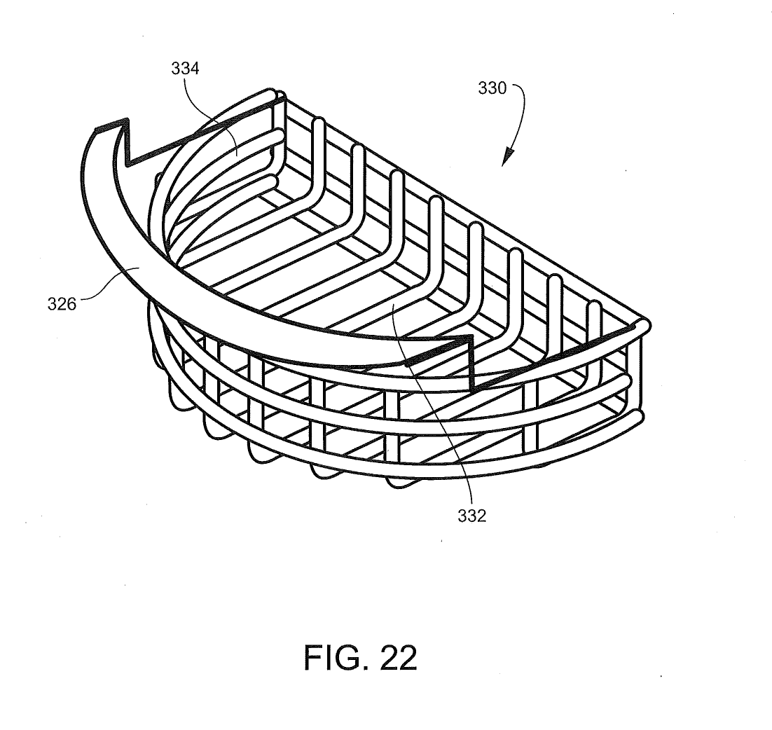

Alternatively, as shown in FIG. 22, a basket 330 is shown, fabricated with a bottom 332, sidewalls 324 and a raised, arcuate support rim 326. In this arrangement, the support rim 326 is positioned on the upper lip of the fire ring 296 and the bottom 332 and the sidewalls 324 are suspended into the fire ring 296. The basket 330 can be used as described above, namely to hold charcoal and to place the fire closer to the grill grate 298. This allows much less fuel to be consumed, and creates a hotter fire that can place a quick sear onto the meat being grilled. Then, the meat can be moved to the other side of the grill grate 298 to allow the meat to cook more slowly to the desired degree of doneness. The basket 330 can also be used to support a pan of water while indirect cooking is taking place. In this example, the charcoal is located on the grate 294 near the bottom of the base 270. Basket 330 is shown in place in the grill 250 of FIG. 18.

Barbeque grill accessories according to the invention have been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

I claim:

1. A barbeque accessory assembly for use with a barbeque grill having an enclosure within which is contained a fire ring positioned over a fire box, and a grill grate positioned in vertically spaced relation above the fire ring, and comprising:
(a) a deflector plate adapted for being positioned in the enclosure between the grill grate and the fire box; and
(b) a plurality of openings extending around the periphery of the deflector plate for permitting heat and smoke to rise along the sides of the grill above the level of the deflector plate into an area of the grille grate where the food is being cooked or smoked.

2. A barbeque accessory assembly according to claim 1, wherein the openings in the deflector plate communicate with an outer peripheral edge of the deflector plate;

3. A barbeque accessory assembly according to claim 1, wherein the openings in the deflector plate communicate with an outer peripheral edge of the deflector plate, and comprise crenellations formed by bending segments of the edge of the deflector plate out of a plane defined by a major surface of the deflector plate.

4. A barbeque accessory assembly according to claim 3, wherein the deflector plate comprises first and second semicircular plate segments.

5. A barbeque accessory assembly according to claim 1, and including a component base for being positioned in the enclosure above the fire box and below the grille grate, and adapted for receiving and supporting the deflector plate.

6. A barbeque accessory assembly according to claim 6, wherein a component bar is provided for extending across the component base from a first side to a second side and the component bar includes a slot for receiving a mating tab formed on a bottom surface of the deflector plate for being inserted in the slot.

7. A barbeque accessory assembly according to claim 1, wherein the enclosure and the grille grate are circular in horizontal cross-section.

8. A barbeque accessory assembly according to claim 1, wherein the openings in the deflector plate extend in an equally-spaced configuration around the periphery of the deflector plate.

9. A barbeque accessory assembly according to claim 7, wherein the deflector plate is circular and sized to fit into the grille enclosure in a closely-fitting position above the fire box and below the grille grate.

10. A barbeque accessory assembly for use with a barbeque grill having an enclosure within which is contained a fire ring positioned over a fire box, and a grill grate positioned in vertically spaced relation above the fire ring, and comprising a basket adapted for being positioned and supported in the enclosure above the firebox and below the grille grate.

11. A barbeque accessory assembly according to claim 10, wherein the basket is sized to be supported on a top surface of the fire box.

12. A barbeque accessory assembly according to claim 10, wherein the basket includes vertically extending sidewalls adapted to extend upwardly away from the fire box and towards the grill grate.

13. A barbeque accessory assembly according to claim 10, wherein the basket includes vertically extending sidewalls adapted to extend upwardly away from the fire box and towards the grill grate, and a flange positioned on the basket above the sidewalls and adapted to rest on an upper peripheral surface of the fire ring above the fire box and below the grill grate, with a bottom of the basket extending below the upper peripheral surface of the fire ring.

14. A barbeque accessory assembly according to claim 10, wherein the enclosure and the grille grate are circular in horizontal cross-section and wherein the shape of the basket is selected from the shapes consisting of semicircular in horizontal cross-section and circular in cross-section.

15. A barbeque accessory assembly according to claim 14, and including a support ring adapted for being positioned on an annular top surface of the fire ring and on which the basket is adapted to rest during use.

16. A barbeque accessory assembly according to claim 15, wherein the support ring is formed of two semicircular ring segments.

17. A basket adapted for being placed in a barbeque grill of the type comprising an enclosure within which is contained a fire ring positioned over a fire box, and a grill grate positioned in vertically spaced relation above the fire ring, the basket further adapted for being positioned and supported in the enclosure above the firebox and below the grille grate.

18. A basket according to claim 17, wherein the basket is sized to be supported on a top surface of the fire box.

19. A basket according to claim 17, wherein the basket includes vertically extending sidewalls adapted to extend upwardly away from the fire box and towards the grill grate.

20. A basket according to claim 10, wherein the basket includes vertically extending sidewalls adapted to extend upwardly away from the fire box and towards the grill grate, and a flange positioned on the basket above the sidewalls and adapted to rest on an upper peripheral surface of the fire ring above the fire box and below the grill grate, with a bottom of the basket extending below the upper peripheral surface of the fire ring.
